(19) United States
(12) Patent Application Publication
(10) Pub. No.: US 2007/0245060 A1
(43) Pub. Date: Oct. 18, 2007

(54) METHOD AND SYSTEM FOR HANDLING DATA BY FILE-SYSTEM OFFLOADING

(76) Inventor: Giridhar Vishwanath Lakkavalli, Bangalore (IN)

Correspondence Address: Ram B. Nath;Prakash Nama, 198 F, 27th Cross. 3rd Block Jayanagar, Bangalore, 560011, IN

(21) Appl. No.: 11/277,521

(22) Filed: Mar. 27, 2006

(51) Int. Cl. G06F 12/00

(52) U.S. Cl. 711/100

(57) ABSTRACT

A system and method for handling data by file system offloading, selectively separates the data-accessing function and data-processing function, wherein a host CPU is used in conjunction with a host OS and a basic FSD. Under control of the host CPU, the basic FSD after initialization, is used to pass-through data-requests to the FSO. A dedicated processor selectively executes the file system logic. The data processing part is expediently done by the host CPU and the data access part is separated out for being addressed by the dedicated processor. Expediently, add-on cards may be used that do offloading till the SCSI layer. In one embodiment, the only part of the storage architecture that is still handled by the host CPU is the file system which can also be offloaded. The invention can be applied to B-tree ® based file systems, or Windows® storage architecture or to Linux® storage architecture with FSO

### FIELD OF THE INVENTION

This invention relates generally to data handling, and more particularly to a method and system for implementing file system offloading to enhance the performance of a server environment.

### BACKGROUND OF THE INVENTION

The two main consumers of CPU processing power in computers as known presently include:

1. Network

2. Disk

Network related data processing involves two paths, the send path and the receive path. On the send path, the CPU needs to construct a network packet to encapsulate the data and send it out on the network. On the receive path, the CPU needs to retrieve the data from the received packets and transfer it to the relevant application. This task though trivial causes a heavy overhead on the CPU with the increase in network speeds.

Disk related data processing again involves two paths, the write path and read path. On the write path, the CPU would be utilized by the file system drivers to determine the sector that needs to be written and then actually write the data. On the read path, the CPU would be utilized to traverse the complex file system structures and then actually read the data.

There has been a significant amount of technology developed to improve Network related data processing and to ensure that it can be geared to meet the increase in network speeds. The technology is called TCP offloading, and TCP offloading is a common term in most server environments. As an extension to this is iSCSI (internet Small Systems Computer Interface) offload which is slowly gaining importance in storage and server environments, and helps in (System Area Network) SAN environments.

However, there is another area that needs to be addressed and this is related to file systems. Increase in disk sizes and OS (Operating System) capabilities mean that larger file systems can be supported.

A few performance characteristics and facts about Disks, CPU architecture and File Systems are considered as background:

Drives:

1. Seagate Barracuda® drives {SATA (Serial Advanced Technology Attachment) and ATA (Advanced Technology Attachment)} can deliver a sustained transfer rate of 65 MB (Mega Byte)/s or 520 Mb (Mega Bit)/s.
2. Seagate Savvio® drives {SAS (Serial Attached SCSI), FC} can deliver a sustained transfer rate of 64 MB/s or 512 Mb/s.
3. Seagate Cheetah® drives {SAS, SCSI (Small computer System Interface), and FC} can deliver a sustained transfer rate of 96 MB/s or 768 Mb/s.

The speeds when the drives are connected individually to a motherboard are indicated in the listing above. Considering the numbers when the drives are connected via an interface like the SATA interface, up to 4 drives can be connected to a SATA interface card and the sustained transfer rate would then be
65*4=280 MB/s or 2.2 Gb(Giga bit)/s.

It is noted that a fiber channel can deliver speeds up to 2 Gbps

The fast Ethernet speed available right now is 1 Gbps and work is in progress to standardize 10 Gbps speed.

It is noted that disks can now deliver an output which is about half what a network interface provides, and networking functionality can already be offloaded.

CPU (Central Processing Unit) s: AMD® and Intel® have introduced single and dual core versions of their 64 bit CPUs. These CPUs are available for servers as well as desktops. It is also noted that with the 64 bit CPUs, there are 64 bits of addressable space available in memory as well as on disk.

It is noted that established file Systems like NTFS (New Technology File System), Reiser FS®, Ext3 and Ext2 can now take advantage of 64 bit addressing space.

New file systems like iSilon's OneFS® can support up to 66.5 TBytes of data.

Also, the file system known as WinFS® seeks to address and catalog every file in the file system.

It is noted that individual file systems can not only be larger but also they can support larger files.

Increasing Use of Disk Intensive Applications Include:

1. Anti Virus software.
2. Data bases.
3. Video\Audio processing software.
4. Backup\Replication software.
5. Compression\Encryption software.
6. Web Service Based Applications.
7. Software RAID (Redundant Array of Independent Disks) applications.
8. Database file systems.

File systems: A definition on the web says that file systems are methods and data structures that an operating system uses to keep track of files on a disk or partition, to control the way the files are organized on the disk. Examples of file systems include FAT12, FAT16, FAT32, EXT2, EXT3, NTFS, Reiser etc. As generally known, the FAT®(File Allocation Table) based file systems are the oldest in existence. FAT and EXT based file systems are index based. NTFS and Reiser® are examples of B-Tree® based file systems.

File Systems are important because they contain all the data required for a computer to boot and perform all the operations. On all operating systems there are specific drivers referred to as the File System drivers that have the logic for creating and managing the file system. File systems are normally organized so the data of the file is stored in a separate location on the disk compared to where the meta-data for the file is stored. When a file system is said to be index based or B-Tree based it usually refers to the way the meta-data of the file is stored.

In index based file systems, a file or a directory is given an ID (Identifier) that is based on the location of the meta-data of the file in the index structures.

In B-Tree based file systems the meta-data of the file is stored in B-Trees and each of the files is again given an ID. B-Tree based file systems are more complex but it is easier to locate files on such file systems.

Index based file systems are less complex file systems but have disadvantages in terms of the amount of time it takes to search for a file on the file system.

The size of these file systems is governed to a large extent by the number of bits that the CPU can address. So, a file system on a 64 bit CPU can grow to a larger size than a file system on a 32 bit CPU.

For every request from an application to locate a file or read file data this will result in calls to the File System Driver (FSD) to locate the data. The driver would initially lookup in the cache if it can retrieve the data, or else, it would read the data off the disk. Caching is usually used by Operating Systems to speed up file access. The file system cache normally stores either a part or whole of the meta-data and some part of the data of a file that is currently being accessed.

There are certain applications which impose big demands on file systems. Consider the file systems that are attached to Web servers catering to request from hundreds or even thousands of clients. Each of these requests could potentially lead to a read-command from a disk. Since the file system logic is embedded in the FSD, the FSD would need to make multiple read-accesses from the disk and also traverse either the Index or a B-Tree to locate a file. Caching the meta-data or the file data for such systems is not productive as the requests themselves can be very unique. Instead of the host CPU being burdened to locate and retrieve the file it could have been used to receive more web requests.

Another scenario to consider is the functioning of the servers attached to big databases. The database sizes can grow to GB (Giga Byte) s or even TB (Terabyte) s based on the amount of information they contain. In such systems, retrieving something from the database would mean that the meta-data on the file system needs to be traversed. If the database is really big, then caching needs to be really good to be effective. It is noted that if the host CPU is not burdened in participating in the search and retrieval of the data, it could service more database requests.

### SUMMARY OF THE INVENTION

This invention provides a method of utilizing and implementing file system offload so that it can benefit a server environment.

One definition of the term Offload: Offload is when the term is used to define the process by which the host CPU relinquishes a part of the work that it was accustomed to doing earlier, to another processor, typically a processor on an add on card. TCP Offloading is the most common term and it refers to a setup where the network processing is predominantly carried out on an add-on card. This frees up the host CPU to do other tasks.

Discussed herein is also the term File System Offloading (FSO). File System Offloading in the context of the present invention comprises, transferring the file system related tasks from the host CPU to another dedicated processor.

As taught in an example described herein, during handling data, the data processing part can be done by the host CPU and the data access part can be separated out for being addressed by a dedicated processor. It is also expedient to have add-on cards that do offloading till the SCSI layer. In one embodiment, the only part of the storage architecture that is still handled by the host CPU is the file system and that part can also be offloaded.

File System Offloading or FSO is beneficial for such scenarios where the server environment needs to be improved. With FSO, the CPU on a host machine can dedicate more time into processing the data rather than spend that time in retrieval of data from the file system. The numbers shown in the context of the discussion on drives and CPU supra indicate that the maximum disk output currently is close to 0.5 Gbps, which means that having a processor dedicated to the file system would improve data retrieval rate to a large extent.

When FSO is implemented, the entire file system logic would selectively be executed on a dedicated processor. The dedicated processor can exist on the HBA (Host Bus Adapter) which currently provides connectivity to a SCSI or IDE (Integrated drive electronics) based disk. If on-board controllers are used, then the FS (File system) logic can be embedded into these on board controllers.

There still would be a Basic FSD that executes under the control of the host CPU. The basic FSD would serve as a pass-through to the requests and would send it directly to the FSO.

The invention in one form resides in a method of handling data by file system offloading, by selective separation of data-accessing function and data-processing function, wherein a host CPU is used in conjunction with a host OS (Operating system) and a basic FSD (File System Driver) interacting with file system logic, comprising: under control of the host CPU, using the basic FSD after initialization, as a pass-through to data-requests and send the data-requests for FSO (File System Offload); and, selectively executing the file system logic on a dedicated processor. Expediently, the FSO works in conjunction with a HBA (Host Bus Adaptor) making a functional unit FSO HBA.

In a second form, the invention resides in a system for handling data by file system offloading, by selective separation of data-accessing function and data-processing function, wherein a host CPU is used in conjunction with a host OS (Operating system) and a basic FSD (File System Driver), comprising: circuitry for using the basic FSD after initialization, under control of the host CPU, as a pass-through to data-requests and to send the data-requests for FSO (File System Offload); and, a dedicated processor for selectively executing file system logic.

Also taught herein is an article comprising a storage medium having instructions thereon which when executed by a computing platform will result in execution of a method for handling data by file system offloading, by selective separation of data-accessing function and data-processing function, wherein a host CPU is used in conjunction with a host OS (Operating system) and a basic FSD (File System Driver) as recited by the method steps supra.

### BRIEF DESCRIPTION OF THE DRAWING

A more detailed understanding of the invention may be had from the following description of embodiments, given by way of example and to be understood in conjunction with the accompanying drawing wherein:

FIG. 1 illustrates a general FSO implementation;

FIG. 2 illustrates a Windows storage architecture, where the present inventive concept can be implemented;

FIG. 3 illustrates a Windows storage architecture with iSCSI offload;

FIG. 4 illustrates a Windows storage architecture with file systems offload;

FIG. 5 illustrates a Linux® Storage architecture with file systems offload; and,

FIG. 6 illustrates a general HBA implementation, according to one embodiment.

### DETAILED DESCRIPTION

A detailed description of one or more embodiments of the invention is provided below to be understood along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. As examples, numerous specific details are set forth in the following description in order to provide a thorough understanding of the present invention.

It is noted that the present invention may be practiced according to the claims without some or all of the specific details. For the purpose of clarity, technical material that is known in the technical fields related to the invention has not been described in detail so that the present invention is not unnecessarily obscured.

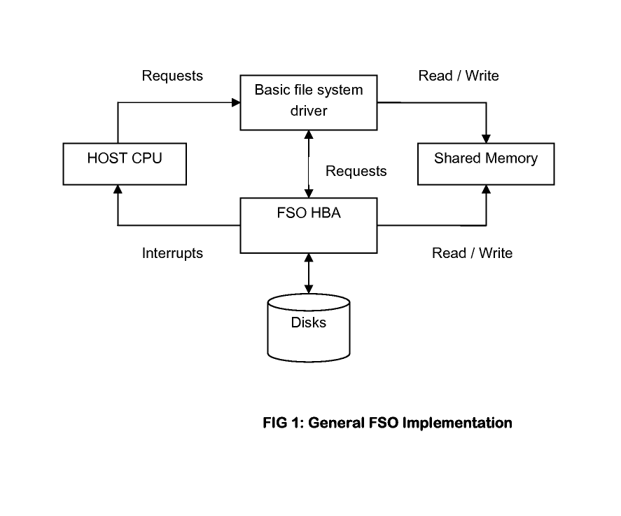

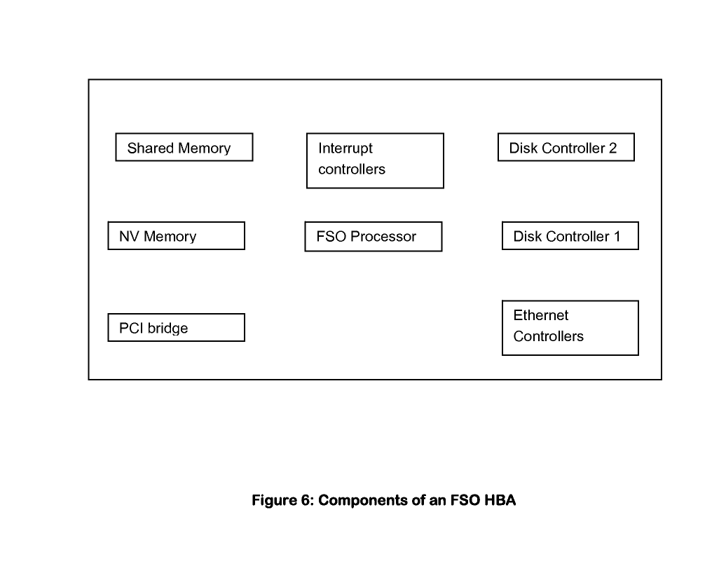

With specific reference to the example illustrated in FIG. 1, all the requests would originate on applications that are executing under the control of the host CPU. The host CPU would then pass it on the Basic FSD which would pass it on to the FSO HBA. There should be a Shared Memory segment which is common to the Basic FSD and the FSO HBA. This memory segment would be used to transfer data to and from the file system. Interruptions would be used by the FSO to send an alert to the host CPU to indicate that data is ready. On a read-request, the host CPU would then direct the Basic FSD to read the data from the shared memory segment and pass it on to the requesting application. On a write-request, the Basic FSD would pass to the FSO HBA the actual request and also a pointer to the write data stored in the shared memory segment. The basic components that are part of an exemplary FSO HBA are shown in FIG. 6. The FIG. 6 illustration includes a shared memory segment and a SATA/IDE/SCSI (Serial Advanced Technology Attachment/Integrated Drive Electronics/Small Computers System Interface) controller.

An FSO implementation (as discussed later) is easy because it can easily fit into the current Storage architectures of Windows® and Linux®.

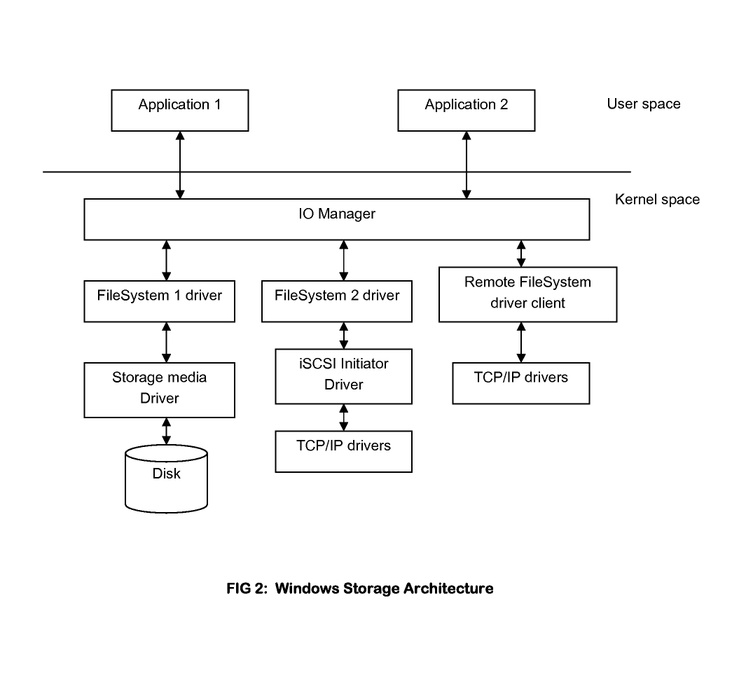

As shown, FIG. 2 covers the current possible storage architecture combinations on Windows. It is noted that the Windows applications interface with the actual File System drivers via the IO Manager. The IO Manager will route the request to the appropriate file system driver. The File System drivers would then pass on the request to the appropriate storage driver. Examples of storage media drivers are SCSI, IDE/ATA (Advanced Technology Attachment), CDROM drivers etc. An iSCSI driver would also get classified as a storage media driver. The iSCSI driver instead of passing the request to the storage media would pass the request to an iSCSI Target via the TCP/IP driver. The third possibility is to have the Remote File System Driver. Examples of Remote file system drivers are CIFS (Common Internet file System) and NFS (Network File System) drivers. These drivers allow access to remote file systems. A remote file system driver would route the request to a remote file system server.

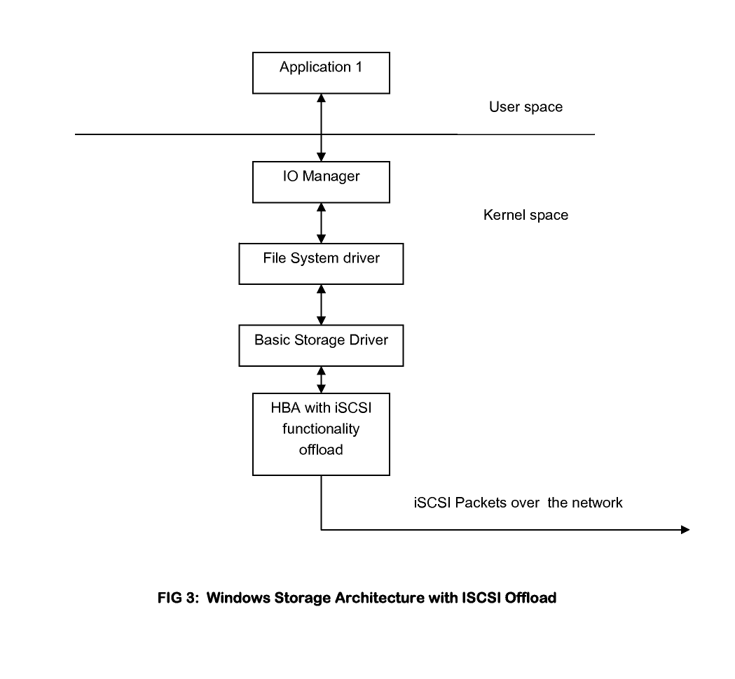

With reference to FIG. 3, this figure shows the Windows storage architecture with iSCSI offload implemented. The file system driver would send requests to the Basic Storage Driver. The Storage driver would pass the requests to the HBA with iSCSI offload. The functionality in the Storage driver would be very basic and would include support for configuring the card and the shared memory that is shared with the card. All other SCSI functionality would be present in the card.

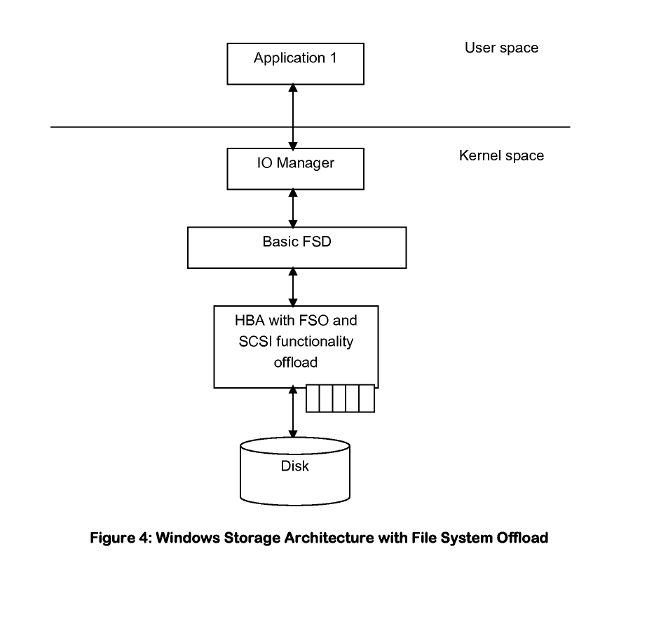

With reference to FIG. 4, with the introduction of the FSO HBA, the storage architecture is as shown. As illustrated, the arrangement in FIG. 4 has eliminated one layer as compared to the other architectures described above. The Basic FS driver would only configure and initialize the FSO HBA. After the initialization is complete, the file system driver acts as a pass-through and routes all the requests without any processing to the HBA. For efficient operation, the HBA and the Basic FSD should share a common memory segment. For all the read and write requests the shared memory should be used. The FSO HBA should typically have support for only one type of file system. It should have the ability to read the partition table and understand the partitioning scheme on the disk. It should then be possible to boot off a disk that has been configured as shown. It is noted that the basic components of an FSO HBA are as shown in FIG. 6, wherein the FSO HBA has a shared memory module that can be used in the data transfer between the Host and the FSO HBA. In addition, the FSO HBA includes a SATA/IDE/SCSI disk controller that it will use to communicate with the storage disks.

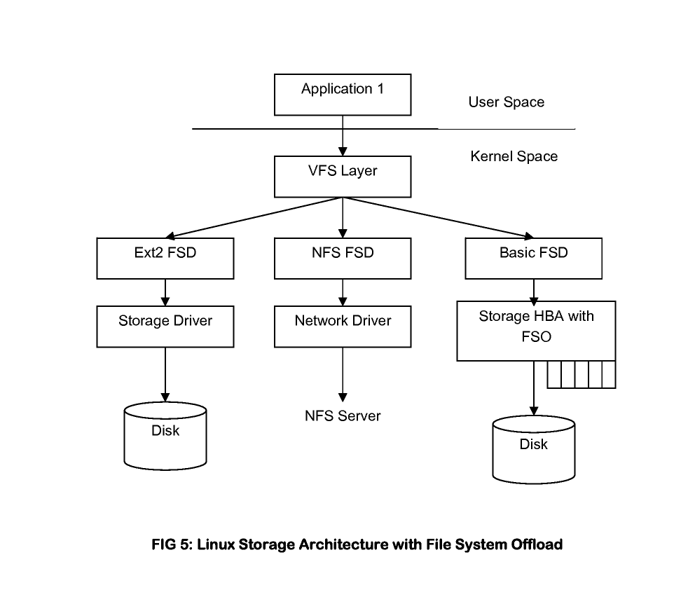

FIG. 5 shows an illustration of the implementation of the FSO in the Linux® storage architecture, showing the user space, and the interacting components in the kernel space. All the file systems need to register with the VFS (Virtual File System). All application requests would first go to the VFS. The VFS would then decide regarding which File System Driver would address the request. The request is then passed on to the right File System Driver. Again, reference may be had in this context to the basic components of the FSO HBA as illustrated in FIG. 6.

FIG. 6 illustrates the components for the FSO HBA Implementation. The FSO HBA would hold the File System logic as well as the logic that is required to interface with the storage. The storage could either be directly attached disks or could be remotely accessible by protocols such as iSCSI. Another variant of the FSO HBA could also communicate with NAS (Network Attached Storage) boxes directly.

An FSO HBA can expediently be an adapter with a PCI interface. The main modules that can be part of an FSO HBA, for example, include:
1. SATA/SAS/SCSI/FC (Fiber Channel)/ATA controllers (Disk Controllers in FIG. 6):

The controllers are required to interface with the actual storage disks on the system. It does not matter what types of disks are present i.e., SATA/SCSI/SAS or ATA disks
2. A processor/microcontroller (FSO processor):

An on board processor or microcontroller is required for the execution of the File System logic and the logic to access the storage (local or remote)
3. Ethernet controllers (Optional):

The Ethernet controllers will play a part only if the FSO HBA needs to access remote disks. In this scenario there would need to be an iSCSI initiator (or something similar) on board the FSO HBA to connect to the remote targets.
4. Shared memory for communication with the host:

As described in the architecture above, the interface with the PC host would be via shared memory. The data that needs to be written to a disk or read from a disk would be placed in the shared memory area and the appropriate recipient would read the data based on a signaling mechanism. The FSO HBA would need to have memory that can be accessed by the PC host.
5. Availability of Operating System ported onto the onboard processor/microcontroller architecture (Optional).
6. The presence of an operating system that has been ported onto a particular processor/microcontroller architecture would simplify the task of implementing the FSO.

The other components that have also been illustrated in the FIG. 6 include:
1. NV (Non Volatile) Memory
   The program logic would reside in the NV Memory. This could be a flash memory or something similar.
2. PCI Bridge:
   The HBA would interact with the host via a PCI interface. While other interfaces for interacting with the host are prevalent, PCI is the most accepted.
3. Interrupt Controllers:
   The interrupt controllers may be used as a signaling mechanism between the Host and the HBA and also as a signaling mechanism between the Disk Controllers and the FSO Processor, and Ethernet Controller and the FSO Processor.

An exemplary Sequence of Operation of one embodiment would be as follows:
1. As part of the loading process of the host OS, the FSO HBA would be detected as a PCI card by the host OS.
2. Two drivers on the host OS would be required:
   a. HBA driver that would claim the card and setup the shared memory access, interrupt access etc. It would also register with the OS the disks that are connected to the card.
   b. A Basic File System Driver would send requests pertaining to the File System to the HBA.
At load time, the HBA would first come into play and claim the card. Hard disks connected to an FSO HBA would typically not be used for booting up the host OS.
3. The Basic FSD would load as part of the load process of the OS.
4. The Basic FSD would register the volumes that are connected to it as accessible drives/volumes. The host OS would assign them well known names (e.g., E:\, F:\, or /data 1, /data 2, etc.) on the host OS.
5. Any requests that are directed to the drives/volumes mapped by the Basic FSD would be received by it.
6. These requests can be sent/received to/from the FSO HBA via the shared memory mechanism described above.

It is noted that Intel® has released a development board (Development Kit) that meets the requirements for incorporating an FSO HBA. The components that are part of the Intel development board include:
1. An on board processor (based on Intel XScale architecture),
2. Four Serial ATA I/O controllers,
3. One Dual-Port Gigabit Ethernet Controller,
4. PCI Interface, and,
5. Real Time OS (Linux®, etc., are natively supported on this card)
   The above Intel Development Kit can serve as a very good platform to develop a prototype to demonstrate the solution offered by the present invention.

As additional implementations of the invention, FSO could play a major role is in Cluster File Systems. The presence of all the file system logic in the FSO HBA would mean that two or more FSOs could form a network of their own and expose a Clustered File System to the hosts that the HBAs reside on.

It is noted that file system reorganization is currently one of the hottest topics in the information storage industry. With the increase in the amount of data that needs to be managed and processed, it has become desirable, as taught herein, to consider actively the task of separating the functionality of accessing the data, from the functionality of processing the data. It is conceivable that FSO can be implemented also on available platforms such as the Intel board referenced above. File system libraries can be developed independently and plugged into the solution taught herein.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter resides in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the spirit and scope of the invention as defined in the appended claims. The scope of the invention should therefore be determined with reference to the appended claims, along with the full scope of equivalents to which such claims are entitled. In the appended claims, the terms “including” and “in which” are used as the plain-English equivalents of the respective terms “comprising” and “wherein,” respectively.

1. A method of handling data by file system offloading, by selective separation of data-accessing function and data-processing function, wherein a host CPU is used in conjunction with a host OS (Operating system) and a basic FSD (File System Driver) interacting with file system logic, comprising:
under control of the host CPU, using the basic FSD after initialization, as a pass-through to data-requests and selectively send the data-requests for FSO (File System Offload); and,
selectively executing the file system logic on a dedicated processor.

2. The method as in claim 1, wherein said FSO works in conjunction with a HBA (Host Bus Adaptor) making a functional unit FSO HBA.

3. The method as in claim 2, including the host OS recognizing said FSO HBA as a PCI (Peripheral Component Interconnect) card.

4. The method as in claim 1, including connecting the basic FSD to cause a loading function as part of a loading process of the host OS.

5. The method as in claim 1, including the step of causing the basic FSD to register connected volumes as accessible drives.

6. The method as in claim 1, including the step of causing the basic FSD to receive requests directed to drives/volumes.

7. The method as in claim 6, wherein said requests comprise requests sent to or received by the FSO HBA via a shared memory mechanism.

8. The method as in claim 3, wherein at loading time, the HBA comes into play and claims said PCI card.

9. The method as in claim 3, including the step of using add-on PCI cards to assist in offloading till an SCSI (Small Computer System Interface) layer.

10. The method as in claim 1, wherein the dedicated processor is on said HBA, which is configured to provide connectivity to an SCSI or an IDE (Integrated Drive Electronics) based disk.

11. The method as in claim 1, wherein the FSD has an architecture applied to Windows®.

12. The method as in claim 1, applied to Windows storage architecture with iSCSI (Internet SCSI) offload.

13. The method as in claim 1, applied to Windows storage architecture with FSO, or to Linux® storage architecture with FSO.

14. The method as in claim 2, where the basic FSD and the HBA share a common memory segment, wherein for read/write requests, a shared memory is used.

15. The method as in claim 2, including configuring the FSO HBA to have an ability to read a partition table on a disk and understand the partitioning.

16. The method as in claim 2, including the step of configuring the FSO HBA to hold file system logic as well as logic to interface with storage.

17. The method as in claim 16, where the storage comprises disks directly attached to the FSO HBA, or, the storage is remotely accessible to an iSCSI protocol.

18. The method as in claim 2, wherein the FSO HBA comprises an adapter with a PCI interface, incorporating any of the controllers SATA, SAS, SCSI, or ATA, or an Ethernet controller, or an FSO processor.

19. The method as in claim 2, wherein the FSO HBA incorporates any of the following: shared memory for communication with the host, or an OS ported on to a processor/microcontroller.

20. The method as in claim 2, including the step of using an interrupt-controller as a signaling mechanism between the host CPU and the HBA, between disk controllers and an FSO processor, and between the FSO processor and Ethernet controller.

21. A system for handling data by file system offloading, by selective separation of data-accessing function and data-processing function, wherein a host CPU is used in conjunction with a host OS (Operating system) and a basic FSD (File System Driver) interacting with file system logic, comprising:
circuitry for using the basic FSD after initialization, under control of the host CPU, as a pass-through to data-requests and to send the data-requests for FSO (File System Offload); and,
a dedicated processor for selectively executing the file system logic.

22. The system as in claim 21, wherein said FSO works in conjunction with a HBA (Host Bus Adaptor) making a functional unit FSO HBA.

23. The system as in claim 22, wherein the host OS recognizes said FSO HBA as a PCI (Peripheral Component Interconnect) card.

24. The system as in claim 21, wherein, the FSD is connected to cause a loading function as part of a loading process of the host OS.

25. The system as in claim 21, wherein the FSD receives requests directed to drives/volumes, and wherein said requests comprise requests sent to or received by the FSO HBA via a shared memory mechanism.

26. The system as in claim 23, wherein at loading time, the HBA comes into play and claims said PCI card.

27. The system as in claim 23, including additional PCI cards to assist in offloading till an SCSI (Small Computer System Interface) layer.

28. The system as in claim 21, wherein the dedicated processor is on said HBA, which is configured to provide connectivity to an SCSI or an IDE (Integrated Drive Electronics) based disk.

29. The system as in claim 21, wherein the FSD has an architecture applied to Windows®.

30. The system as in claim 21, applied to Windows storage architecture with iSCSI (Internet SCSI) offload.

31. The system as in claim 21, applied to Windows storage architecture with FSO, or to Linux® storage architecture with FSO.

32. The system as in claim 22, where the basic FSD and the HBA share a common memory segment, wherein for read/write requests, a shared memory is used.

33. The system as in claim 22, wherein the FSO HBA has an ability to read a partition table on a disk and understand the partitioning.

34. The system as in claim 22, wherein the FSO HBA is configured to hold file system logic as well as logic to interface with storage, where the storage comprises disks directly attached to the FSO HBA, or, the storage is remotely accessible to an iSCSI protocol.

35. The system as in claim 22, wherein the FSO HBA comprises an adapter with a PCI interface, incorporating any of the controllers SATA, SAS, SCSI, or ATA, or an Ethernet controller, or an FSO processor.

36. The system as in claim 22, wherein the FSO HBA incorporates any of the following: shared memory for communication with the host, or an OS ported on to a processor/microcontroller.

37. The system as in claim 22, including an interrupt-controller used as a signaling mechanism selectively between the host CPU and the HBA, between disk controllers and an FSO processor, and between the FSO processor and Ethernet controller.

38. An article comprising a storage medium having instructions thereon which when executed by a computing platform will result in execution of a method for handling data by file system offloading, by selective separation of data-accessing function and data-processing function, wherein a host CPU is used in conjunction with a host OS (Operating system) and a basic FSD (File System Driver), comprising the steps:
under control of the host CPU, using the basic FSD after initialization, as a pass-through to data-requests and send the data-requests for FSO (File System Offload); and,
selectively executing file system logic on a dedicated processor.
